(19) United States
(12) Patent Application Publication
(10) Pub. No.: US 2025/0224286 A1
(43) Pub. Date: Jul. 10, 2025

(54) SENSOR CHIP, PRESSURE SENSOR, METHOD OF FABRICATING PRESSURE SENSOR

(71) Applicants: Beijing BOE Sensor Technology Co., Ltd., Beijing (CN); BOE Technology Group Co., Ltd., Beijing (CN); Beijing BOE Technology Development Co., Ltd., Beijing (CN)

(72) Inventors: Weilong Guo, Beijing (CN); Yue Li, Beijing (CN); Qiuxu Wei, Beijing (CN); Lihui Wang, Beijing (CN); Taonan Zhang, Beijing (CN); Nana He, Beijing (CN); Jie Sun, Beijing (CN); Wenbo Chang, Beijing (CN); Feng Qu, Beijing (CN)

(73) Assignees: Beijing BOE Sensor Technology Co., Ltd., Beijing (CN); BOE Technology Group Co., Ltd., Beijing (CN); Beijing BOE Technology Development Co., Ltd., Beijing (CN)

(21) Appl. No.: 18/689,819

(22) PCT Filed: Jun. 20, 2023
(86) PCT No.: PCT/CN2023/101242

§ 371 Date: Mar. 6, 2024

(51) Int. Cl. G01L 1/18

(52) U.S. Cl. CPC G01L 1/18

(57) ABSTRACT

A sensor chip is provided. The sensor chip includes a first base substrate; a piezoresistor and a resistor lead on the first base substrate; a second base substrate on a side of the piezoresistor and the resistor lead away from the first base substrate; a metal wire bond extending through the second base substrate and connected to the resistor lead; a redistribution layer on a side of the second base substrate away from the first base substrate; and a pressure reference chamber between the first base substrate and the second base substrate. The first base substrate and the second base substrate encapsulate at least a portion of the piezoresistor inside the pressure reference chamber. The metal wire bond is connected to the resistor lead, and is connected to the redistribution layer. The resistor lead is connected to the piezoresistor.

### TECHNICAL FIELD

The present invention relates to display technology, more particularly, to a sensor chip, a pressure sensor, and a method of fabricating a pressure sensor.

### BACKGROUND

A pressure sensor is an electronic device that converts pressure signals into electrical signals. These sensors can be classified into four main types based on the principles of pressure chips: resistive, capacitive, resonant, and piezoelectric. Among these, silicon resistive pressure sensors are the most extensively utilized due to their advantages, such as a simple manufacturing process, low cost, high reliability, and compatibility with complementary metal-oxide-semiconductor (CMOS) technology. In 2020, resistive pressure sensors accounted for approximately 85% of the entire market for micro-electro-mechanical systems (MEMS) pressure sensors, establishing them as the dominant choice. These sensors have a wide range of applications in various industries, including automotive, industrial control, consumer electronics, construction, medical, and other sectors. Consequently, they are currently considered the most widely employed MEMS pressure sensors.

### SUMMARY

In one aspect, the present disclosure provides a sensor chip, comprising a first base substrate; a piezoresistor and a resistor lead on the first base substrate; a second base substrate on a side of the piezoresistor and the resistor lead away from the first base substrate; a metal wire bond extending through the second base substrate and connected to the resistor lead; a redistribution layer on a side of the second base substrate away from the first base substrate; and a pressure reference chamber between the first base substrate and the second base substrate; wherein the first base substrate and the second base substrate encapsulate at least a portion of the piezoresistor inside the pressure reference chamber; the metal wire bond is connected to the resistor lead, and is connected to the redistribution layer; and the resistor lead is connected to the piezoresistor.

Optionally, the sensor chip further comprises an under bump metallization on a side of the second base substrate away from the first base substrate; and a solder on a side of the under bump metallization away from the second base substrate and connected to the under bump metallization.

Optionally, the sensor chip comprises a via extending through the second base substrate; wherein the metal wire bond is at least partially in the via, the via has a trapezoidal shape with an included angle between a top side and a lateral side; and the included angle is in a range of 80 degrees to 90 degrees.

Optionally, the sensor chip comprises a pressure sensing layer configured to convert a pressure signal into a deformation signal; wherein the pressure sensing layer comprises a portion of the first base substrate between the two piezoresistors; and the piezoresistor is configured to convert the deformation signal into an electrical signal.

Optionally, a surface of the portion of the first base substrate between the two piezoresistors is exposed to the pressure reference chamber.

Optionally, the sensor chip further comprises an insulating layer on the first base substrate; wherein the piezoresistor and the resistor lead are on a side of the insulating layer away from the first base substrate; the pressure reference chamber is between the insulating layer and the second base substrate; and the insulating layer and the second base substrate encapsulate at least a portion of the piezoresistor inside the pressure reference chamber.

Optionally, the sensor chip comprises a pressure sensing layer configured to convert a pressure signal into a deformation signal; wherein the pressure sensing layer comprises a portion of the first base substrate and a portion of the insulating layer between two piezoresistors; and the piezoresistor is configured to convert the deformation signal into an electrical signal.

Optionally, a surface of the portion of the insulating layer between the two piezoresistors is exposed to the pressure reference chamber.

Optionally, the sensor chip further comprises a thermistor on a side of the second base substrate away from the first base substrate.

Optionally, the sensor chip further comprises a hygrometer on a side of the second base substrate away from the first base substrate.

In another aspect, the present disclosure provides a pressure sensor, comprising a first base substrate; a pressure sensing layer on the first base substrate; a releasing via extending through the pressure sensing layer, a sealing layer on a side of the pressure sensing layer away from the first base substrate, the sealing layer sealing the releasing via; and a pressure reference chamber between the first base substrate and the pressure sensing layer.

Optionally, the pressure sensor further comprises a first etch stop layer on the first base substrate and on a side of the pressure reference chamber closer to the first base substrate; and a second etch stop layer on a side of the first etch stop layer away from the first base substrate, the second etch stop layer surrounding a periphery of the pressure reference chamber; wherein the pressure sensing layer, the first etch stop layer, and the second etch stop layer encapsulate the pressure reference chamber.

Optionally, the second etch stop layer comprises doped polycrystalline silicon.

Optionally, the first base substrate and the pressure sensing layer encapsulate the pressure reference chamber.

Optionally, the pressure sensor further comprises a first electrode on the first base substrate; and a first etch stop layer on a side of the first electrode away from the first base substrate; wherein the pressure sensing layer and the first etch stop layer encapsulate the pressure reference chamber.

Optionally, an orthographic projection of the pressure reference chamber on the first base substrate covers an orthographic projection of the releasing via on the first base substrate.

Optionally, an orthographic projection of the releasing via on the first base substrate is at least partially non-overlapping with an orthographic projection of the pressure reference chamber on the first base substrate.

In another aspect, the present disclosure provides a method of forming a pressure sensor, comprising forming a pressure sensing layer on a first base substrate; forming a releasing via extending through the pressure sensing layer; forming a sealing layer on a side of the pressure sensing layer away from the first base substrate, the sealing layer sealing the releasing via; and forming a pressure reference chamber between the first base substrate and the pressure sensing layer.

Optionally, the method further comprises forming a first etch stop layer on the first base substrate; forming a sacrificial layer on a side of the first etch stop layer away from the first base substrate; performing an ion implantation process on a portion of the sacrificial layer, thereby forming a second etch stop layer in a peripheral region of the sacrificial layer, forming a third etch stop layer on a side of the sacrificial layer and the second etch stop layer away from the first etch stop layer; forming the releasing via extending through the third etch stop layer, and selectively removing the sacrificial layer, thereby forming the pressure reference chamber.

Optionally, the first etch stop layer has an etching rate with respect to a same etchant at least less than 50% of an etching rate of the sacrificial layer with respect to the same etchant; the second etch stop layer has an etching rate with respect to the same etchant at least less than 50% of the etching rate of the sacrificial layer with respect to the same etchant; and the third etch stop layer has an etching rate with respect to the same etchant at least less than 50% of the etching rate of the sacrificial layer with respect to the same etchant.

Optionally, the method further comprises forming a first etch stop layer on the first base substrate; patterning the first etch stop layer to form a second etch stop layer, thereby exposing a portion of the first base substrate; performing a thermal oxidation process on the portion of the first base substrate, thereby forming a first thermal oxide layer, partially removing the first thermal oxide layer to reduce a thickness of the first thermal oxide layer, thereby forming a second thermal oxide layer, removing the second etch stop layer; forming a third etch stop layer on a side of the second thermal oxide layer away from the first base substrate; forming the releasing via extending through the third etch stop layer; and selectively removing the second thermal oxide layer, thereby forming the pressure reference chamber.

Optionally, the first base substrate has an etching rate with respect to a same etchant at least less than 50% of an etching rate of the second thermal oxide layer with respect to the same etchant; and the third etch stop layer has an etching rate with respect to the same etchant at least less than 50% of the etching rate of the second thermal oxide layer with respect to the same etchant.

Optionally, the method further comprises forming a first etch stop layer on the first base substrate; patterning the first etch stop layer to form a second etch stop layer, thereby exposing a portion of the first base substrate; performing a thermal oxidation process on the portion of the first base substrate, thereby forming a first thermal oxide layer; patterning the second etch stop layer to form a third etch stop layer, thereby exposing an additional portion of the first base substrate; performing a second thermal oxidation process on the additional portion of the first base substrate and the first thermal oxide layer, thereby converting the first thermal oxide layer into a second thermal oxide layer, and converting a part of the additional portion of the first base substrate into a third thermal oxide layer; removing the third etch stop layer; forming a fourth etch stop layer on a side of the second thermal oxide layer and the third thermal oxide layer away from the first base substrate; forming the releasing via extending through the fourth etch stop layer; and selectively removing the second thermal oxide layer and the third thermal oxide layer, thereby forming the pressure reference chamber.

Optionally, the first base substrate has an etching rate with respect to a same etchant at least less than 50% of an etching rate of the second thermal oxide layer with respect to the same etchant; and the fourth etch stop layer has an etching rate with respect to the same etchant at least less than 50% of the etching rate of the second thermal oxide layer with respect to the same etchant.

Optionally, the method further comprises forming a first photoresist on a first region of the first base substrate, and absent on a second region of the first base substrate; performing an ion implantation process on the first base substrate using the first photoresist as a mask, thereby converting the second region of the first base substrate into a first electrode; removing the first photoresist; forming a first etch stop layer on a side of the first electrode away from the first base substrate; forming a sacrificial layer on a side of the first etch stop layer away from the first electrode; forming a second etch stop layer on a side of the sacrificial layer away from the first etch stop layer; forming the releasing via extending through the second etch stop layer; and selectively removing the sacrificial layer, thereby forming the pressure reference chamber.

Optionally, the first etch stop layer has an etching rate with respect to a same etchant at least less than 50% of an etching rate of the sacrificial layer with respect to the same etchant; and the second etch stop layer has an etching rate with respect to the same etchant at least less than 50% of the etching rate of the sacrificial layer with respect to the same etchant.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a sensor chip in some embodiments according to the present disclosure.

FIG. 2 illustrates the Wheatstone bridge principle.

FIG. 3 is a schematic diagram illustrating the structure of a Wheatstone bridge.

FIG. 4 is a schematic diagram illustrating the structure of a sensor chip in some embodiments according to the present disclosure.

FIG. 5 illustrates a layout of piezoresistors and resistor leads on a first base substrate of a sensor chip in some embodiments according to the present disclosure.

FIG. 6 illustrates a layout of metal wire bondings and under bump metallizations on a second base substrate of a sensor chip in some embodiments according to the present disclosure.

FIG. 7A to FIG. 7J illustrates a process of fabricating a sensor chip in some embodiments according to the present disclosure.

FIG. 8 illustrates a via extending through a second base substrate in some embodiments according to the present disclosure.

FIG. 9 is a schematic diagram illustrating the structure of a sensor chip in some embodiments according to the present disclosure.

FIG. 10A to FIG. 10J illustrates a process of fabricating a sensor chip in some embodiments according to the present disclosure.

FIG. 11 is a schematic diagram illustrating the structure of a sensor chip in some embodiments according to the present disclosure.

FIG. 12 illustrates a layout of piezoresistors, thermistor, and resistor leads on a first base substrate of a sensor chip in some embodiments according to the present disclosure.

FIG. 13A to FIG. 13J illustrates a process of fabricating a sensor chip in some embodiments according to the present disclosure.

FIG. 14 is a schematic diagram illustrating the structure of a sensor chip in some embodiments according to the present disclosure.

FIG. 15 illustrates a layout of piezoresistors, thermistor, and resistor leads on a first base substrate of a sensor chip in some embodiments according to the present disclosure.

FIG. 16A to FIG. 16J illustrates a process of fabricating a sensor chip in some embodiments according to the present disclosure.

FIG. 17 is a schematic diagram illustrating the structure of a pressure sensor in some embodiments according to the present disclosure.

FIG. 18A to 18H illustrates a process of fabricating a pressure sensor in some embodiments according to the present disclosure.

FIG. 19 is a schematic diagram illustrating the structure of a pressure sensor in some embodiments according to the present disclosure.

FIG. 20A to 20H illustrates a process of fabricating a pressure sensor in some embodiments according to the present disclosure.

FIG. 21 is a schematic diagram illustrating the structure of a pressure sensor in some embodiments according to the present disclosure.

FIG. 22A to 22J illustrates a process of fabricating a pressure sensor in some embodiments according to the present disclosure.

FIG. 23 is a plan view of channels in a pressure sensor in some embodiments according to the present disclosure.

FIG. 24 is a schematic diagram illustrating the structure of a pressure sensor in some embodiments according to the present disclosure.

FIG. 25A to 25I illustrates a process of fabricating a pressure sensor in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

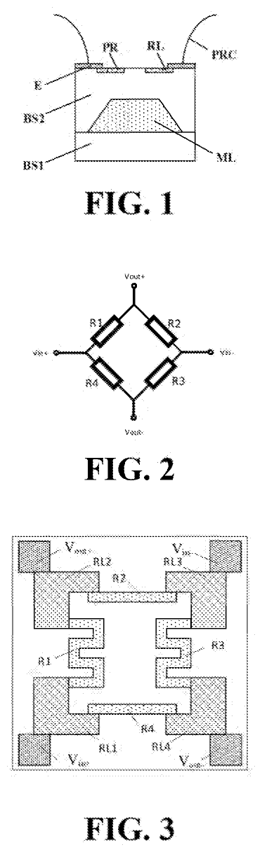

Pressure sensors typically comprise three main components: a sensing chip, processing circuitry, and packaging. The sensing chip, serving as the core component, directly detects pressure signals. FIG. 1 is a schematic diagram illustrating the structure of a sensor chip in some embodiments according to the present disclosure. Referring to FIG. 1, the sensing chip in some embodiments includes a first base substrate BS1, a metal lead ML on the first base substrate BS1, a second base substrate BS2 on a side of the metal lead ML away from the first base substrate BS1, a piezoresistor PR and a resistor lead RL on a side of the second base substrate BS2 away from the metal lead ML, an electrode E on a side of the piezoresistor PR and the resistor lead RL away from the second base substrate BS2, and a pressure reference chamber PRC on a side of the electrode E away from the second base substrate BS2. Notably, the piezoresistor PR, responsible for the main electrical functionality, is exposed to the external environment outside the pressure reference chamber PRC (e.g., a vacuum chamber). Consequently, it becomes susceptible to external influences, leading to potential drift or failure in electrical performance. The inventors of the present disclosure discover that the environmental adaptability of the sensor chip with such a configuration is limited, resulting in lower reliability.

In the sensor chip depicted in FIG. 1, the chip's measurement circuit is based on the Wheatstone bridge principle. FIG. 2 illustrates the Wheatstone bridge principle. Referring to FIG. 2, the input voltage of the Wheatstone bridge is defined as Vᵢₙ=Vᵢₙ₊−Vᵢₙ₋, while the output voltage is represented as Vₒᵤₜ=Vₒᵤₜ₊−Vₒᵤₜ₋, The piezoresistor resistors R1, R2, R3, and R4 correspond to the four bridge arms of the Wheatstone bridge, and Van can be expressed as:

$${V}_{out} = {V}_{in} ( \frac{{R}_{2}}{{R}_{1} + {R}_{2}} - \frac{{R}_{3}}{{R}_{3} + {R}_{4}} ) \\ {V}_{out} = {V}_{in} \frac{Δ R}{R}$$

During the fabrication process of the sensing chip, R1=R2=R3=R4=R. When external pressure acts upon the sensing chip, the piezoresistor resistors R1 and R3 decrease by ΔR, resulting in their resistance becoming R−ΔR, Conversely, the piezoresistor resistors R2 and R4 increase by ΔR, causing their resistance to become R+ΔR. As a result, Vou undergoes a change, and the variation in Vou is directly proportional to the applied pressure on the sensor chip. This process converts the pressure signal into a voltage signal.

FIG. 3 is a schematic diagram illustrating the structure of a Wheatstone bridge. The sensor chip depicted in FIG. 2 and FIG. 3 includes piezoresistor resistors R1, R2, R3, and R4, electrodes Vᵢₙ₊, Vᵢₙ₋, Vₒᵤₜ₊, Vₒᵤₜ₋, and resistor leads RL1, RL2, RL3, and RL4 connecting piezoresistor resistors and electrodes. As shown in FIG. 3, the electrodes and the resistor leads occupy over 50% of the total circuit area. The inventors of the present disclosure discover that this is one of the reasons why current piezoresistor chips have relatively larger sizes. With the development of miniaturization, intelligence, and integration in electronic devices, there is a growing demand for smaller piezoresistor pressure chips.

Accordingly, the present disclosure provides, inter alia, a sensor chip, a pressure sensor, and a method of fabricating a pressure sensor that substantially obviate one or more of the problems due to limitations and disadvantages of the related art. In one aspect, the present disclosure provides a sensor chip. In some embodiments, the sensor chip includes a first base substrate; a piezoresistor and a resistor lead on the first base substrate; a second base substrate on a side of the piezoresistor and the resistor lead away from the first base substrate; a metal wire bond extending through the second base substrate and connected to the resistor lead; a redistribution layer on a side of the second base substrate away from the first base substrate; and a pressure reference chamber between the first base substrate and the second base substrate. Optionally, the first base substrate and the second base substrate encapsulate at least a portion of the piezoresistor inside the pressure reference chamber. Optionally, the metal wire bond is connected to the resistor lead, and is connected to the redistribution layer. Optionally, the resistor lead is connected to the piezoresistor.

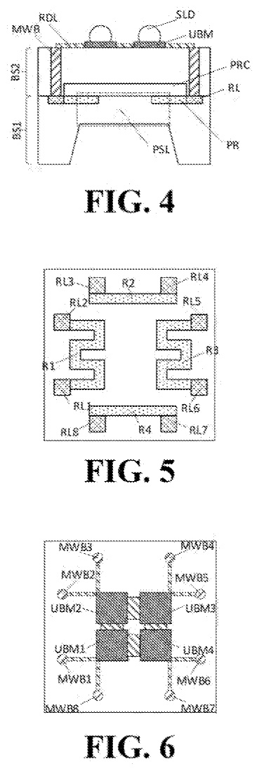

FIG. 4 is a schematic diagram illustrating the structure of a sensor chip in some embodiments according to the present disclosure, Referring to FIG. 4, the sensor chip in some embodiments includes a first base substrate BS1, a piezoresistor PR and a resistor lead RL on the first base substrate BS1, a second base substrate BS2 on a side of the piezoresistor PR and the resistor lead RL away from the first base substrate BS1, a metal wire bond MWB extending through the second base substrate BS2 and connected to the resistor lead RL, a redistribution layer RDL and an under bump metallization UBM on a side of the second base substrate BS2 away from the first base substrate BS1, and a solder SLD on a side of the under bump metallization UBM away from the second base substrate BS2 and connected to the under bump metallization UBM.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC, In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal,

FIG. 5 illustrates a layout of piezoresistors and resistor leads on a first base substrate of a sensor chip in some embodiments according to the present disclosure. Referring to FIG. 5, the sensor chip in some embodiments includes piezoresistor resistors R1, R2, R3, and R4, and resistor leads RL1, RL2, RL3, RL4, RL5, RL6, RL7, and RL8, A first piezoresistor resistor R1 is connected to the resistor leads RL1 and RL2, A second piezoresistor resistor R2 is connected to the resistor leads RL3 and RL4, A third piezoresistor resistor R3 is connected to the resistor leads RL5 and RL6. A fourth piezoresistor resistor R4 is connected to the resistor leads RL7 and RL8.

The circuit structure depicted in FIG. 5 is much miniaturized as compared to the circuit structure depicted in FIG. 3. The circuit structure on the first base substrate BS1 depicted in FIG. 5 includes only piezoresistors and resistor leads, but not electrodes. The dimensions of the resistor leads have been reduced accordingly, resulting in a significant decrease in the size of the sensor chip.

FIG. 6 illustrates a layout of metal wire bondings and under bump metallizations on a second base substrate of a sensor chip in some embodiments according to the present disclosure. Referring to FIG. 6, the sensor chip in some embodiments includes metal wire bondings MWB1, MWB2, MWB3, MWB4, MWB5, MWB6, MWB7, and MWB8; and under bump metallizations UBM1, UBM2, UBM3, and UBM4, The metal wire bondings MWB1, MWB2, MWB3, MWB4, MWB5, MWB6, MWB7, and MWB8 are connected to the resistor leads RL1, RL2, RL3, RL4, RL5, RL6, RL7, and RL8 on the first base substrate depicted in FIG. 5.

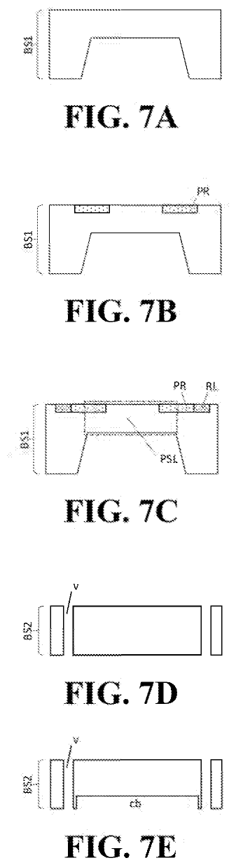

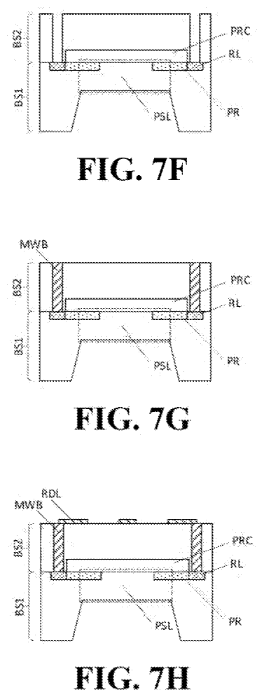

FIG. 7A to FIG. 7J illustrates a process of fabricating a sensor chip in some embodiments according to the present disclosure. Referring to FIG. 7A, a first base substrate BS1 is formed. In some embodiments, the first base substrate BS1 is a silicon-based base substrate. In one example, a silicon substrate (e.g., a N (100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 7B, a piezoresistor PR is formed on the first base substrate BSL. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-100002/square after annealing.

Referring to FIG. 7C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 7D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via y with a specific aspect ratio.

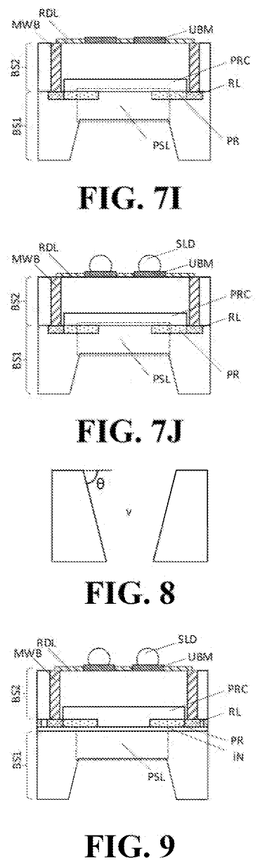

FIG. 8 illustrates a via extending through a second base substrate in some embodiments according to the present disclosure. Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 7E, a chamber cb is formed in the second base substrate BS2, When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 7F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 7G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 7H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 7I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 7J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

In some embodiments, the piezoresistor PR is a p-type diffused resistor, and the pressure sensing layer PSL is an n-type pressure sensing layer (e.g., a silicon-based pressure sensing layer). The electrical insulation between the piezoresistor PR and the pressure sensing layer PSL is achieved through a p-n junction. The inventors of the present disclosure discover that, when an operating temperature exceeds 125 degrees, it can cause intrinsic excitation of the semiconductor, leading to more vigorous molecular motion. This results in electrons breaking free from covalent bonds, increasing the concentration of “free electrons” and the leakage current across the p-n junction between between the piezoresistor PR and the pressure sensing layer PSL. The p-n junction becomes ineffective, rendering the sensor unable to measure pressure in high-temperature environments. With the development of applications in fields such as petroleum, chemical, metallurgy, industrial process control, defense industry, and food industry, pressure measurement in high-temperature environments has become particularly important.

In some embodiments, a silicon-on-insulator substrate may be used as the first base substrate. FIG. 9 is a schematic diagram illustrating the structure of a sensor chip in some embodiments according to the present disclosure. Referring to FIG. 9, the sensor chip in some embodiments includes a first base substrate BS1, an insulating layer IN on the first base substrate BS1, a piezoresistor PR and a resistor lead RL on a side of the insulating layer IN away from the first base substrate BS1, a second base substrate BS2 on a side of the piezoresistor PR and the resistor lead RL away from the insulating layer IN, a metal wire bond MWB extending through the second base substrate BS2 and connected to the resistor lead RL, a redistribution layer RDL and an under bump metallization UBM on a side of the second base substrate BS2 away from the first base substrate BS1, and a solder SLD on a side of the under bump metallization UBM away from the second base substrate BS2 and connected to the under bump metallization UBM.

The inventors of the present disclosure discover that, surprisingly and unexpectedly, by having the insulating layer IN, the sensor chip may be operational in a much higher temperature range. In one example, the sensor chip having the insulating layer IN allows for a maximum operating temperature of 500 degrees.

Various appropriate insulating materials and various appropriate fabricating methods may be used to make the insulating layer IN. For example, an insulating material may be deposited on the first base substrate BS1 by a plasma-enhanced chemical vapor deposition (PECVD) process. Examples of materials suitable for making the insulating layer IN include, but are not limited to, silicon oxide (SiOx), silicon nitride (SiNx), or a combination thereof. In one example, the insulating layer IN includes silicon oxide.

In some embodiments, the sensor chip further includes a pressure reference chamber PRC between the insulating layer IN and the second base substrate BS2. The insulating layer IN and the second base substrate BS2 encapsulate at least a portion of the piezoresistor PR inside the pressure reference chamber PRC.

In some embodiments, the sensor chip includes a pressure sensing layer PSL. The pressure sensing layer PSL in some embodiments includes a portion of the first base substrate BS1 and a portion of the insulating layer IN between two piezoresistors. Optionally, a surface of the portion of the insulating layer IN between the two piezoresistors is exposed to the pressure reference chamber PRC.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

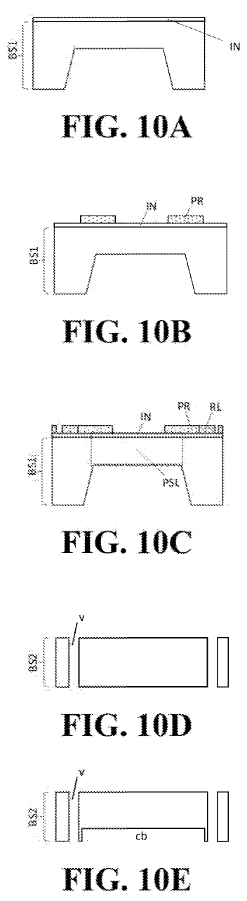

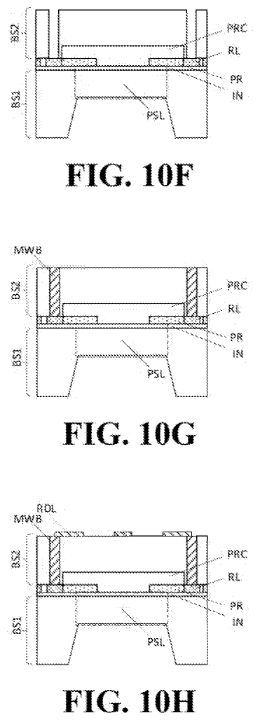

FIG. 10A to FIG. 10J illustrates a process of fabricating a sensor chip in some embodiments according to the present disclosure. Referring to FIG. 10A, a first base substrate is formed, and an insulating layer IN is formed on the first base substrate BS1. In some embodiments, the first base substrate BS1 is a silicon-based base substrate. In one example, a silicon substrate (e.g., a N (100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 10B, a piezoresistor PR is formed on the first base substrate BS1. In some embodiments, the piezoresistor PR is formed using a photolithography process. In one example, a photoresist is formed on the insulating layer IN as a mask for ion implantation. After the ion implantation process, inductively coupled plasma etching is performed, with the insulating layer IN as an etching stop layer for the etching process. After etching, the photoresist is removed, and the substrate is annealed. In one example, the piezoresistor PR has a resistance value of 5-100002/square after annealing.

Referring to FIG. 10C, a resistor lead RL is formed on the first base substrate BS1. In some embodiments, the resistor lead RL is formed using a photolithography process. In one example, a photoresist is formed on the insulating layer IN as a mask for ion implantation. After the ion implantation process, inductively coupled plasma etching is performed, with the insulating layer IN as an etching stop layer for the etching process. After etching, the photoresist is removed, and the substrate is annealed. In one example, the resistor lead RL has a resistance value of 5-100002/square after annealing.

Referring to FIG. 10D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 10E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber ch is to be formed, creating modified regions. Subsequently, wet etching is employed to etch the laser-modified regions into the desired shape, forming the chamber cb.

Referring to FIG. 10F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 10G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 10H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 10I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 10J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

In some embodiments, the sensor chip further includes a thermistor configured to detect a temperature, without the need of increasing the volume of the sensor chip. A thermistor, also known as a temperature sensing resistor, is a type of sensor used to measure temperature. It operates based on the characteristic of the material's resistance changing with temperature, Common thermistor materials include platinum (Pt100) and nickel-chromium alloys (NiCr—Ni). As the temperature changes, the resistance of the thermistor also changes, and this change can be used to calculate the temperature value. Typically, the thermistor material is mounted on a supporting structure to ensure proper contact with the temperature being measured. A certain amount of current is then passed through the circuit, and the temperature variation is inferred by measuring the corresponding resistance change. Additionally, calibration and compensation techniques are employed to improve accuracy and stability.

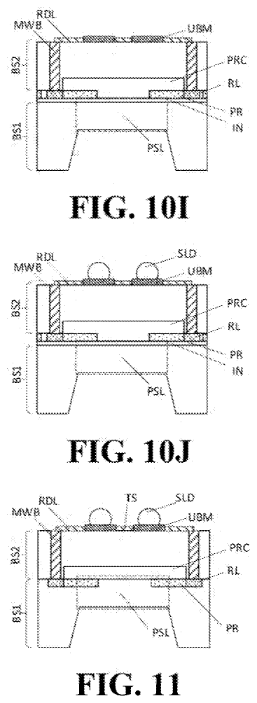

FIG. 11 is a schematic diagram illustrating the structure of a sensor chip in some embodiments according to the present disclosure. Referring to FIG. 11, the sensor chip in some embodiments includes a first base substrate BS1, a piezoresistor PR and a resistor lead RL on the first base substrate BS1, a second base substrate BS2 on a side of the piezoresistor PR and the resistor lead RL away from the first base substrate BS1, a metal wire bond MWB extending through the second base substrate BS2 and connected to the resistor lead RL, a redistribution layer RDL, a thermistor TS, and an under bump metallization UBM on a side of the second base substrate BS2 away from the first base substrate BS1, and a solder SLD on a side of the under bump metallization UBM away from the second base substrate BS2 and connected to the under bump metallization UBM.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

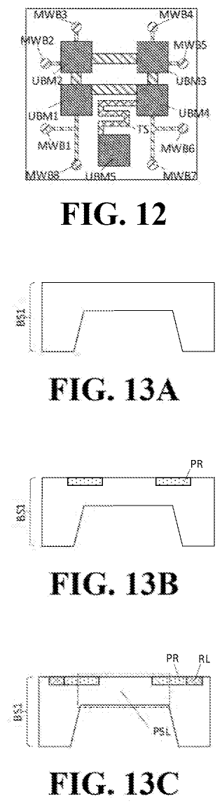

FIG. 12 illustrates a layout of piezoresistors, thermistor, and resistor leads on a first base substrate of a sensor chip in some embodiments according to the present disclosure Referring to FIG. 12, the sensor chip in some embodiments includes metal wire bondings MWB1, MWB2, MWB3, MWB4, MWB5, MWB6, MWB7, and MWB8; under bump metallizations UBM1, UBM2, UBM3, UBM4, and UBM5; and a thermistor TS. In one example, the thermistor TS is connected to the under bump metallization UBM4, and is connected to the under bump metallization UBM5.

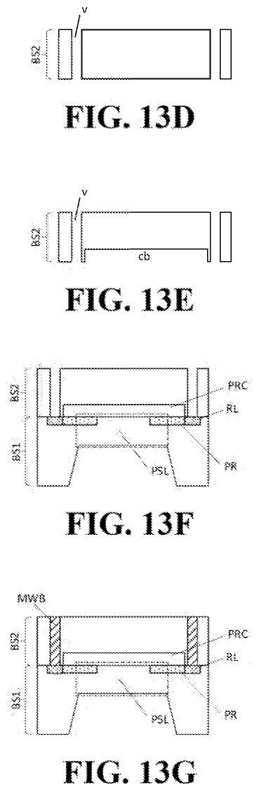

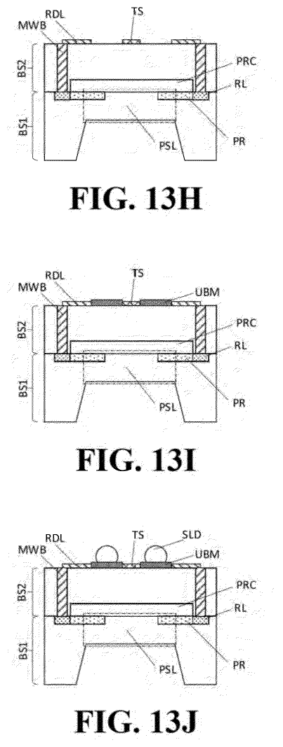

FIG. 13A to FIG. 13J illustrates a process of fabricating a sensor chip in some embodiments according to the present disclosure. Referring to FIG. 13A, a first base substrate BS1 is formed. In some embodiments, the first base substrate BS1 is a silicon-based base substrate. In one example, a silicon substrate (e.g., a N (100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 13B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate B$1 is annealed. In one example, the piezoresistor PR has a resistance value of 100-10000/square after annealing.

Referring to FIG. 13C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10052/square after annealing.

Referring to FIG. 13D, a via v is formed extending through the second base substrate BS2, In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 13E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 13F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 13G, a metal wire bonding MWB is formed extending through the via in the second base substrate BS2. In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 nm, and comprising titanium or chromium. In another example, the plating layer is made of copper and fills the via.

Referring to FIG. 13H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 13H, a thermistor TS is formed on the second base substrate BS2. In one example, an adhesion layer is first deposited on a surface of the second base substrate BS2; and a temperature sensing layer is then deposited on the adhesion layer, e.g., using a physical vapor deposition process or a chemical vapor deposition process. In another example, the adhesion layer has a thickness of 20-50 nm, and comprising titanium or chromium. In another example, the temperature sensing layer has a thickness of 0.1-1.0 μm, and is made of platinum or nickel. Subsequent to the deposition, a photolithography process is performed to form the pattern of the thermistor TS.

Referring to FIG. 13I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 13J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

In some embodiments, the sensor chip further includes a hygrometer configured to detect humidity, without the need of increasing the volume of the sensor chip. For example, a capacitive hygrometer measures humidity based on the capacitance changes in a capacitor caused by the adsorption or desorption of moisture on its surface. The basic principle of a capacitive hygrometer is that the dielectric constant of a material changes with the amount of moisture it absorbs. The sensor consists of two conductive plates with a dielectric material in between, and as the humidity changes, the dielectric constant of the material changes, thereby altering the capacitance of the sensor. By measuring this capacitance change, the humidity level can be determined.

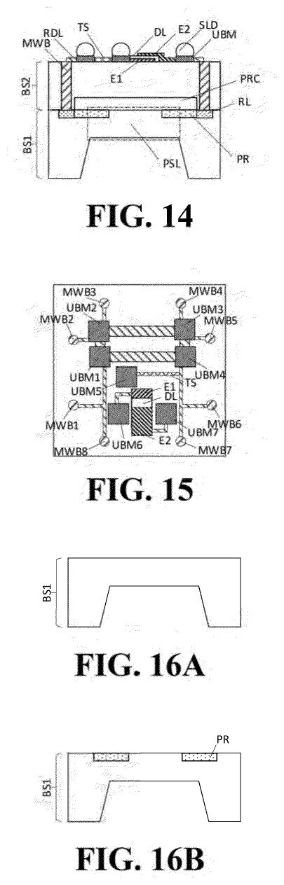

FIG. 14 is a schematic diagram illustrating the structure of a sensor chip in some embodiments according to the present disclosure. Referring to FIG. 14, the sensor chip in some embodiments includes a first base substrate BS1, a piezoresistor PR and a resistor lead RL on the first base substrate BS1, a second base substrate BS2 on a side of the piezoresistor PR and the resistor lead RL away from the first base substrate BS1, a metal wire bond MWB extending through the second base substrate BS2 and connected to the resistor lead RL, a redistribution layer RDL, a thermistor TS, a hygrometer HM, and an under bump metallization UBM on a side of the second base substrate BS2 away from the first base substrate BS1, and a solder SLD on a side of the under bump metallization UBM away from the second base substrate BS2 and connected to the under bump metallization UBM.

In some embodiments, the hygrometer HM includes a first electrode E1 on the second base substrate BS2, a dielectric layer DL on a side of the first electrode E1 away from the second base substrate BS2, and a second electrode E2 on a side of the dielectric layer DL away from the first electrode E1.

In some embodiments, the sensor chip further includes a pressure reference chamber PRC between the first base substrate BS1 and the second base substrate BS2. The first base substrate BS1 and the second base substrate BS2 encapsulate at least a portion of the piezoresistor PR inside the pressure reference chamber PRC.

In some embodiments, the first base substrate BS1 includes a portion between two piezoresistors. Optionally, a surface of the portion of the first base substrate BS1 between the two piezoresistors is exposed to the pressure reference chamber PRC. In some embodiments, the sensor chip includes a pressure sensing layer PSL. The pressure sensing layer PSL includes the portion of the first base substrate BS1 between the two piezoresistors.

In some embodiments, the metal wire bond MWB extending through the second base substrate BS2 connects the resistor lead RL with the redistribution layer RDL. The resistor lead RL is connected to the piezoresistor PR. In some embodiments, a signal in the piezoresistor PR is transmitted through the resistor lead RL and the metal wire bond MWB to the redistribution layer RDL. The redistribution layer RDL is configured to transmit the signal to the under bump metallization UBM, and in turn to the solder SLD. Optionally, the solder SLD is an output terminal of the sensor chip.

In some embodiments, the solder SLD is configured to transmit an input signal through the under bump metallization UBM to the redistribution layer RDL. The redistribution layer RDL is configured to transmit the input signal through the metal wire bond MWB to the resistor lead RL and the piezoresistor PR. Optionally, the solder SLD is an input terminal of the sensor chip.

The under bump metallization UBM serves as the electrical connection structure of the sensor chip, transmitting electrical signals from the redistribution layer RDL to the solder SLD, acts as the bonding layer between the redistribution layer RDL and the solder SLD, and prevents diffusion of solder material into the redistribution layer RDL.

The pressure inside the pressure reference chamber PRC serves as a reference pressure for measuring the pressure of the sensor chip. When an external pressure equals the pressure inside the pressure reference chamber PRC, the output of the sensor chip is zero. When the external pressure exceeds the pressure inside the pressure reference chamber PRC, the output of the sensor chip is the difference between the external atmospheric pressure and the pressure inside the pressure reference chamber PRC.

The piezoresistor PR is configured to convert the deformation of the pressure sensing layer PSL into electrical signals.

The pressure sensing layer PSL is configured to convert the pressure signal into a deformation signal.

FIG. 15 illustrates a layout of piezoresistors, thermistor, and resistor leads on a first base substrate of a sensor chip in some embodiments according to the present disclosure.

Referring to FIG. 15, the sensor chip in some embodiments includes metal wire bondings MWB1, MWB2, MWB3, MWB4, MWB5, MWB6, MWB7, and MWB8; under bump metallizations UBM1, UBM2, UBM3, UBM4, UBM5, UBM6, and UBM7; a thermistor TS, and a hygrometer. In one example, the thermistor TS is connected to the under bump metallization UBM4, and is connected to the under bump metallization UBM5, In another example, the hygrometer includes a first electrode E1, a dielectric layer DL, and a second electrode E2, In another example, the first electrode E1 is connected to the under bump metallization UBM6, and the second electrode E2 is connected to the under bump metallization UBM7.

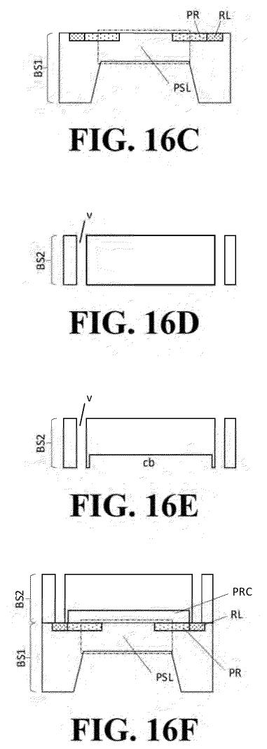

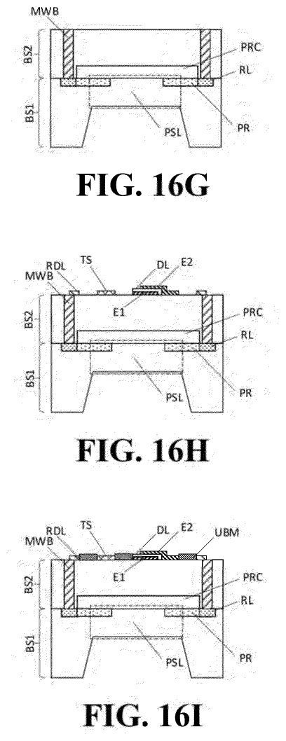

FIG. 16A to FIG. 16J illustrates a process of fabricating a sensor chip in some embodiments according to the present disclosure. Referring to FIG. 16A, a first base substrate BS1 is formed. In some embodiments, the first base substrate BS1 is a silicon-based base substrate. In one example, a silicon substrate (e.g., a N (100) silicon substrate) is provided, silicon nitride is grown on both sides as a mask. After the deposition of silicon nitride, the shape required for the pressure-sensitive film is lithographically defined on the bottom of the silicon substrate. Wet etching of the silicon substrate is performed using a hot alkaline solution (such as potassium hydroxide or tetramethylammonium hydroxide). After etching, the silicon nitride mask layer is removed using a hot phosphoric acid solution.

Referring to FIG. 16B, a piezoresistor PR is formed on the first base substrate BS1. In some embodiments, the piezoresistor PR is formed using a photolithography process. In one example, a photoresist is formed on the first base substrate BS1 as a mask for ion implantation. After the ion implantation process, the photoresist is removed, and the first base substrate BS1 is annealed. In one example, the piezoresistor PR has a resistance value of 100-100052/square after annealing.

Referring to FIG. 16C, a resistor lead RL is formed on the first base substrate BS1. In some embodiments, the resistor lead RL is formed using a photolithography process. In one example, a photoresist is formed on the first base substrate BS1 as a mask for ion implantation. After the ion implantation process, the photoresist is removed, and the first base substrate BS1 is annealed. In one example, the resistor lead RL has a resistance value of 20-10002/square after annealing.

Referring to FIG. 16D, a via v is formed extending through the second base substrate BS2. In some embodiments, the second base substrate BS2 is a glass-based base substrate. In one example, a glass-based base substrate (e.g., BF33 or 7740 glass) is provided. The glass base substrate is patterned to create the via v. In one example, the via v has a diameter ranging from 10 to 1000 μm. In another example, laser-induced etching technology may be employed to form the via v. Laser-induced modification is initially performed on the glass base substrate using lasers to create modified regions in the areas where the via v is to be formed. Subsequently, wet etching is employed to etch the laser-modified regions into the via v with a specific aspect ratio.

Referring to FIG. 8, in some embodiments, the via v has a trapezoidal shape with an included angle θ between a top side and a lateral side. In some embodiments, the included angle θ is in a range of 80 degrees to 90 degrees.

Referring to FIG. 16E, a chamber cb is formed in the second base substrate BS2. When the second base substrate BS2 and the first base substrate BS1 are assembled together, the chamber cb becomes the pressure reference chamber. In one example, laser-induced etching technology may be employed to form the chamber cb. Laser-induced modification is initially performed on the glass base substrate by treating it with lasers. The lasers are used to scan the areas where the chamber cb is to be formed, creating modified regions. Subsequently, wet etching is employed to etch the laser-modified regions into the desired shape, forming the chamber cb.

Referring to FIG. 16F, the first base substrate BS1 and the second base substrate BS2 are assembled together. In one example, anodic bonding technique may be employed to bond the first base substrate BS1 and the second base substrate BS2 together. During the bonding process, the first base substrate BS1 is connected to a positive terminal of a power supply, while the second base substrate BS2 is connected to a negative terminal of the power supply. In one example, a voltage ranging from 200V to 1000V and a temperature ranging from 100° C. to 500° C. are applied in the bonding process.

Referring to FIG. 16G, a metal wire bonding MWB is formed extending through the via in the second base substrate BS2, In one example, an adhesion layer is first deposited on an inner wall of the via, e.g., using a physical vapor deposition process or a chemical vapor deposition process. A plating layer is then deposited on the inner wall of the via. In another example, the adhesion layer has a thickness of 20-50 mm, and comprising titanium or chromium. In another example, the plating layer is made of copper and fills the via.

Referring to FIG. 16H, a redistribution layer RDL is formed on the second base substrate BS2. In one example, an adhesion layer is first deposited on a surface of the second base substrate BS2; and a plating layer is then deposited on the adhesion layer, e.g., using a physical vapor deposition process or a chemical vapor deposition process. In another example, the adhesion layer has a thickness of 20-50 nm, and comprising titanium or chromium. In another example, the plating layer has a thickness of 0.2-0.5 nm, and is made of copper. Subsequent to the plating process, photolithography is performed to create the pattern of the redistribution layer RDL.

Referring to FIG. 16H, a thermistor TS is formed on the second base substrate BS2. In one example, an adhesion layer is first deposited on a surface of the second base substrate BS2; and a temperature sensing layer is then deposited on the adhesion layer, e.g., using a physical vapor deposition process or a chemical vapor deposition process. In another example, the adhesion layer has a thickness of 20-50 nm, and comprising titanium or chromium. In another example, the temperature sensing layer has a thickness of 0.1-1.0 am, and is made of platinum or nickel. Subsequent to the deposition, a photolithography process is performed to form the pattern of the thermistor TS.

Referring to FIG. 16H, a hygrometer HM is formed on the second base substrate BS2. In one example, an adhesion layer is first deposited on a surface of the second base substrate BS2. In another example, the adhesion layer has a thickness of 20-50 nm, and comprising titanium or chromium. A first electrode E1 is then formed on a side of the adhesion layer away from the second base substrate BS2. In one example, the first electrode E1 has a thickness of 0.1-1 μm, and comprising gold. Subsequent to the deposition, a lithography process is performed to form the pattern of the first electrode E1, A dielectric layer DL is then formed on a side of the first electrode E1 away from the adhesion layer. In one example, the dielectric layer DL is made of a polymer material with humidity sensing functionality, such as polyethylene glycol or polyimide. The dielectric layer DL is coated using spin coating or spray adhesive methods, and then lithography is performed to form the pattern of the dielectric layer DL, A second electrode E2 is then formed on a side of the dielectric layer DL away from the first electrode E1. In one example, the second electrode E2 has a thickness of 0.1-1 μm, and comprising gold. Subsequent to the deposition, a lithography process is performed to form the pattern of the second electrode E2.

Referring to FIG. 16I, an under bump metallization UBM is formed on the second base substrate BS2. In one example, an under bump metallization material is deposited on the second base substrate BS2, e.g., using a physical vapor deposition process or a chemical vapor deposition process. In one example, the under bump metallization UBM has a thickness in a range of 2 to 15 μm. In another example, the under bump metallization material includes indium or an alloy material such as copper-tin.

Referring to FIG. 16J, a solder SLD is formed on the under bump metallization UBM. In some embodiments, screen printing is used for forming the solder SLD. In one example, a metal solder paste is applied on the second base substrate BS2 by screen printing, and a reflow soldering process is performed to form the solder SLD.

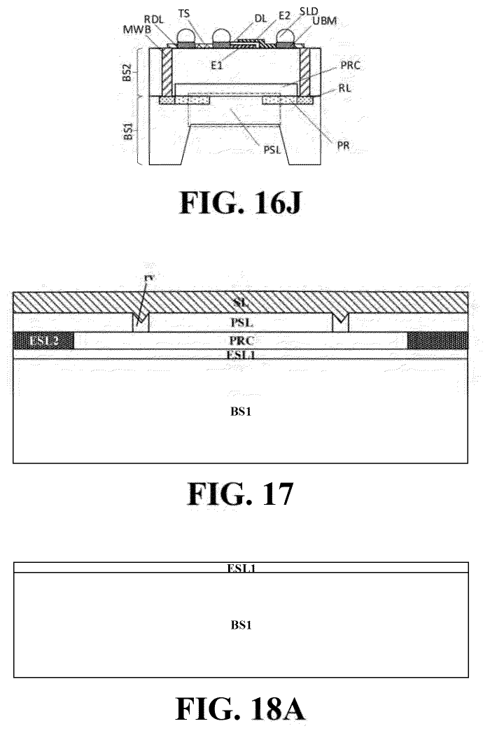

The sensor chip according to the present disclosure may be implemented in various appropriate pressure sensors. FIG. 17 is a schematic diagram illustrating the structure of a pressure sensor in some embodiments according to the present disclosure. Referring to FIG. 17, the pressure sensor in some embodiments includes a first base substrate BS1, a first etch stop layer ESL1 on the first base substrate BS1, a second etch stop layer ESL2 on a side of the first etch stop layer ESL1 away from the first base substrate BS1, a pressure sensing layer PSL on a side of the second etch stop layer ESL2 away from the first etch stop layer ESL1, a releasing via rv extending through the pressure sensing layer PSL, and a sealing layer SL on a side of the pressure sensing layer PSL away from the first base substrate BS1, the sealing layer SL sealing the releasing via rv. The pressure sensing layer PSL, the first etch stop layer ESL1, and the second etch stop layer ESL2 encapsulate a pressure reference chamber PRC.

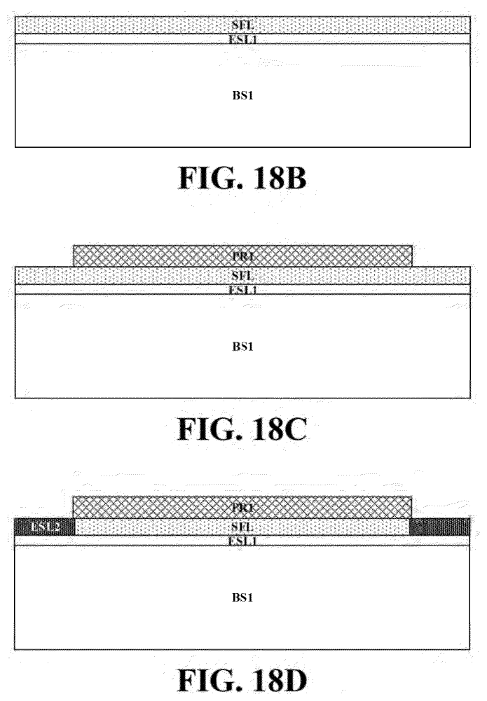

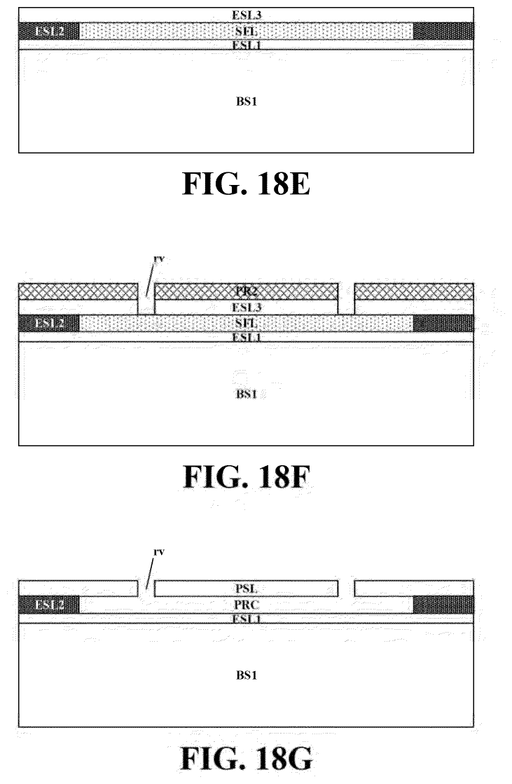

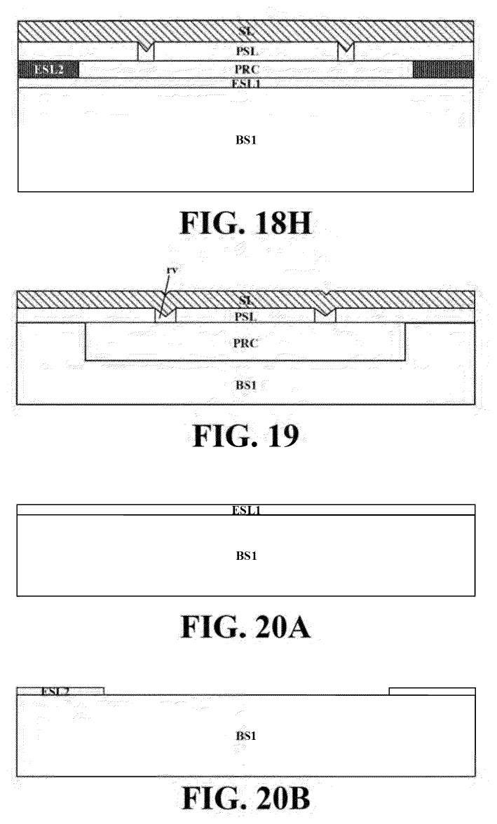

FIG. 18A to 18H illustrates a process of fabricating a pressure sensor in some embodiments according to the present disclosure. Referring to FIG. 18A, a first base substrate BS1 is formed, and a first etch stop layer ESL1 is formed on the first base substrate BS1, In some embodiments, the first base substrate BS1 is a silicon-based base substrate. In one example, the first base substrate BS1 includes single crystal silicon.

In one example, the first etch stop layer ESL1 includes silicon oxide or silicon nitride.

Referring to FIG. 18B, a sacrificial layer SEL is formed on a side of the first etch stop layer ESL1 away from the first base substrate BS1. As used herein, the term “sacrificial layer” refers to a temporary layer of material that is intentionally deposited or formed during the fabrication process of a device or structure and is later removed or dissolved. The sacrificial layer is typically used to facilitate the creation of specific features or structures that would be difficult or impossible to achieve directly. It acts as a sacrificial template or support during the fabrication steps and is then selectively removed, leaving behind the desired pattern or structure. The sacrificial layer can be made from various materials, depending on the manufacturing process and the requirements of the final product. Common sacrificial materials include polymers, metals, oxides, or even organic compounds that can be easily dissolved or etched away without damaging the surrounding materials. In some embodiments, the sacrificial layer SFL includes undoped polycrystalline silicon.

Referring to FIG. 18C, a first photoresist PR1 is formed on a side of the sacrificial layer SEL away from the first etch stop layer ESL1. A peripheral region of the sacrificial layer SFL is not covered by the first photoresist PR1. A central region of the sacrificial layer SFL is covered by the first photoresist PR1.

Referring to FIG. 18D, an ion implantation process is performed on the sacrificial layer SFL to form a second etch stop layer ESL2 in a peripheral region of the sacrificial layer SEL. In one example, high-concentration ions are implanted into the peripheral region of the sacrificial layer SFL using ion injection, followed by annealing. The central region of the sacrificial layer SFL is protected by the first photoresist PR1, and is undoped. The undoped regions form the desired cavity patterns for etching. The doped region forms the second etch stop layer ESL2.

Various appropriate dopants may be used in the ion implantation process. Examples of appropriate dopants include boron, phosphorus, and arsenic. A typical dosage of ions is in the range of 3×e¹⁵/cm² to 1×e¹⁶/cm². After the first photoresist PR1 is removed, a rapid thermal annealing or furnace annealing process is conducted to activate the implanted ions and form heavily doped polycrystalline silicon in the second etch stop layer ESL2.

In some embodiments, the second etch stop layer ESL2 and the sacrificial layer SFL have different etching selectivity with respect to a same etchant, e.g., a wet etchant. In one example, the second etch stop layer ESL2 and the sacrificial layer SFL have different etching selectivity with respect to an alkaline etchant such as sodium hydroxide, potassium hydroxide, and tetramethylammonium hydroxide. Optionally, the second etch stop layer ESL2 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the sacrificial layer SFL with respect to the same etchant.

In some embodiments, the first etch stop layer ESL1 and the sacrificial layer SEL have different etching selectivity with respect to a same etchant, e.g., a wet etchant. In one example, the first etch stop layer ESL1 and the sacrificial layer SFL have different etching selectivity with respect to an alkaline etchant such as sodium hydroxide, potassium hydroxide, and tetramethylammonium hydroxide. Optionally, the first etch stop layer ESL1 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the sacrificial layer SFL with respect to the same etchant.

Referring to FIG. 18E, a third etch stop layer ESL3 is formed on a side of the sacrificial layer SFL and the second etch stop layer ESL2 away from the first etch stop layer ESL1. Optionally, forming the third etch stop layer ESL3 includes depositing a pressure sensing material on a side of the sacrificial layer SFL and the second etch stop layer ESL2 away from the first etch stop layer ESL1.

In some embodiments, the third etch stop layer ESL3 and the sacrificial layer SFL have different etching selectivity with respect to a same etchant, e.g., a wet etchant. In one example, the third etch stop layer ESL3 and the sacrificial layer SFL have different etching selectivity with respect to an alkaline etchant such as sodium hydroxide, potassium hydroxide, and tetramethylammonium hydroxide. Optionally, the third etch stop layer ESL3 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the sacrificial layer SPL with respect to the same etchant.

In one example, the third etch stop layer ESL3 includes silicon oxide or silicon nitride. In another example, the third etch stop layer ESL3 includes a metal such as platinum (Pt) of chromium (Cr).

Referring to FIG. 18F, a second photoresist PR2 is formed on a side of the third etch stop layer ESL3 away from the sacrificial layer SFL and the second etch stop layer ESL2, and a releasing via rv is formed to extend through the second photoresist PR2 and the third etch stop layer ESL3, exposing at least a portion of the sacrificial layer SFL, Optionally, the releasing via rv may be formed by an etching process, e.g., using a dry etchant or a wet etchant.

Referring to FIG. 18G, the second photoresist PR2 is removed, and an etchant is used to selectively etch the sacrificial layer SFL, thereby forming a pressure reference chamber PRC and a pressure sensing layer PSL on a side of the pressure reference chamber PRC away from the first etch stop layer ESL1. The releasing via rv extends through the pressure sensing layer PSL.

Referring to FIG. 18H, a sealing layer SL is formed on a side of the pressure sensing layer PSL away from the pressure reference chamber PRC, sealing the releasing via rv. In one example, the sealing layer SL includes a dielectric material. In another example, the sealing layer SL includes a metallic material. In another example, the sealing layer SL includes a polysilicon material.

FIG. 19 is a schematic diagram illustrating the structure of a pressure sensor in some embodiments according to the present disclosure. Referring to FIG. 19, the pressure sensor in some embodiments includes a first base substrate BS1, a pressure sensing layer PSL on the first base substrate BS1, a releasing via rv extending through the pressure sensing layer PSL, and a sealing layer SL on a side of the pressure sensing layer PSL away from the first base substrate BS1, the sealing layer SL sealing the releasing via ry. The first base substrate BS1 and the pressure sensing layer PSL encapsulate a pressure reference chamber PRC.

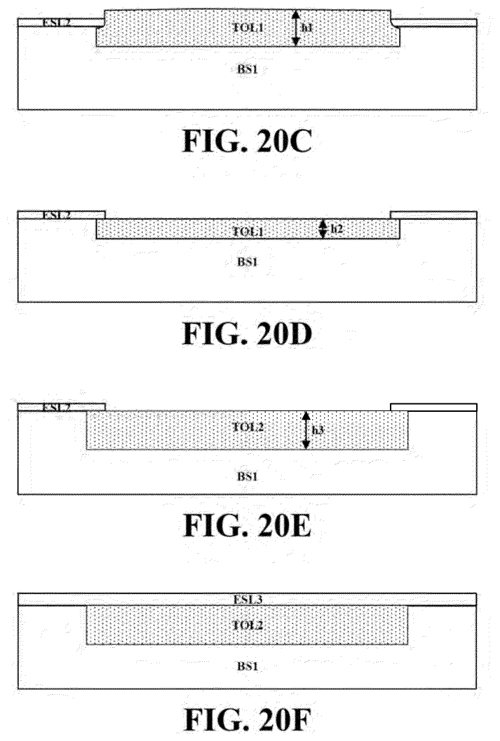

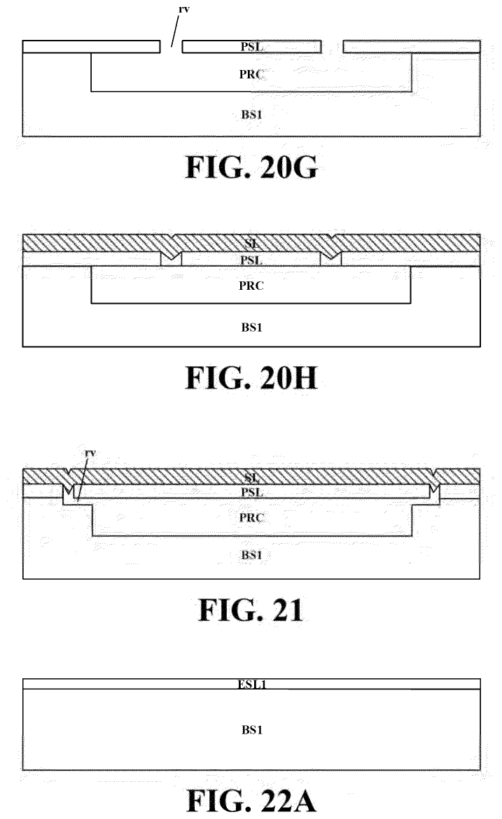

FIG. 20A to 20H illustrates a process of fabricating a pressure sensor in some embodiments according to the present disclosure. Referring to FIG. 20A, a first base substrate BS1 is formed, and a first etch stop layer ESL1 is formed on the first base substrate BS1. In some embodiments, the first base substrate BS1 is a silicon-based base substrate. In one example, the first base substrate BS1 includes single crystal silicon.

In one example, the first etch stop layer ESL1 includes silicon oxide or silicon nitride.

Referring to FIG. 20B, the first etch stop layer ESL1 is etched to form a second etch stop layer ESL2. In some embodiments, a central region of the first etch stop layer ESL1 is removed, exposing a portion of the first base substrate BS1. A peripheral region of the first etch stop layer ESL1 at least partially remains, thereby forming the second etch stop layer ESL2.

Referring to FIG. 20C, a thermal oxidation process is performed to treat the portion of the first base substrate BS1 that is exposed. The thermal oxidation process, also known as thermal oxide growth, is a method used to form a layer of oxide on a silicon substrate through a high-temperature oxidation reaction. During the thermal oxidation process, the silicon substrate is exposed to an oxygen-containing atmosphere at elevated temperatures. The most common ambient used is dry oxygen (O₂) or a mixture of oxygen and other gases. The oxidation reaction occurs at the surface of the silicon, where oxygen molecules combine with silicon atoms to form silicon dioxide (SiO₂). Typically, the silicon substrate is heated to a high temperature, typically in the range of 800 to 1200 degrees Celsius, in the presence of the oxygen-containing ambient. As the silicon reacts with oxygen, a layer of silicon dioxide is formed on the surface of the silicon substrate. This oxide layer grows gradually, consuming silicon from the substrate. After the desired oxide thickness is achieved, the substrate is annealed at a lower temperature to relieve stress and improve the quality of the oxide layer. The thickness of the thermal oxide layer is determined by several factors, including the oxidation time, temperature, and the concentration of oxygen in the ambient. The growth rate of the oxide layer is generally linear with time under controlled oxidation conditions.

Referring to FIG. 20C, the portion of the first base substrate BS1 that is exposed is subject to the thermal oxidation process, forming a first thermal oxide layer TOL1 having a thickness of h1. When single-crystal silicon is oxidized, the generation of h1 thickness of thermal oxide consumes 0.44*h1 thickness of silicon. As a result, the first thermal oxide layer TOL1 is higher than the surface of the first base substrate BS1 in a region in direct contact with the second etch stop layer ESL2.

In alternative embodiments, the thermal oxidation process is not used. Instead, the first base substrate BS1 is etched to remove a portion of the first base substrate BS1 that is not covered by the second etch stop layer ESL2; and subsequently a dielectric layer is directly deposited on the first base substrate BS1. Optionally, the dielectric layer is formed to have a thickness of 0.44*h1. In one example, the dielectric layer includes silicon oxide.

Referring to FIG. 20C and FIG. 20D, the first thermal oxide layer TOL1 in FIG. 20C can be at least partially removed to have a thickness h2, wherein h2 is less than h1.

Referring to FIG. 20D and FIG. 20E, a second thermal oxidation process can be performed to form a second thermal oxide layer TOL2 having a thickness of h3, wherein h3=0.786h1. Optionally, subsequent to the second thermal oxidation process, a height of the second thermal oxide layer TOL2 is substantially the same as a height of a portion of the first base substrate BS1 covered by the second etch stop layer ESL2.

Referring to FIG. 20C and FIG. 20F, subsequent to forming the second thermal oxide layer TOL2, the second etch stop layer ESL2 is removed. Subsequently, a third etch stop layer ESL3 is formed on a side of the second thermal oxide layer TOL2 away from the first base substrate BS1. Optionally, forming the third etch stop layer ESL3 includes depositing a pressure sensing material on a side of the second thermal oxide layer TOL2 away from the first base substrate BS1.

In one example, the third etch stop layer ESL3 includes silicon oxide or silicon nitride. In another example, the third etch stop layer ESL3 includes a metal such as platinum (Pt) or chromium (Cr).

In some embodiments, the first base substrate BS1 and the second thermal oxide layer TOL2 have different etching selectivity with respect to a same etchant, e.g., a wet etchant. In one example, the first base substrate BS1 and the second thermal oxide layer TOL2 have different etching selectivity with respect to a fluorine-containing etchant such as hydrogen fluoride, Optionally, the first base substrate BS1 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the second thermal oxide layer TOL2 with respect to the same etchant.

In some embodiments, the third etch stop layer ESL3 and the second thermal oxide layer TOL2 have different etching selectivity with respect to a same etchant, e.g., a wet etchant. In one example, the third etch stop layer ESL3 and the second thermal oxide layer TOL2 have different etching selectivity with respect to a fluorine-containing etchant such as hydrogen fluoride. Optionally, the third etch stop layer ESL3 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the second thermal oxide layer TOL2 with respect to the same etchant.

Referring to FIG. 20F and FIG. 20G, a releasing via rv is formed to extend through the third etch stop layer ESL3. Optionally, the releasing via rv may be formed by an etching process, e.g., using a dry etchant or a wet etchant. Subsequently, an etchant is used to selectively etch the second thermal oxide layer TOL2, thereby forming a pressure reference chamber PRC and a pressure sensing layer PSL on a side of the pressure reference chamber PRC away from the first base substrate BS1. The releasing via rv extends through the pressure sensing layer PSL.

Referring to FIG. 20H, a sealing layer SL is formed on a side of the pressure sensing, layer PSL away from the pressure reference chamber PRC, sealing the releasing via rv. In one example, the sealing layer SL includes a dielectric material. In another example, the sealing layer SL includes a metallic material. In another example, the sealing layer SL includes a polysilicon material.

FIG. 21 is a schematic diagram illustrating the structure of a pressure sensor in some embodiments according to the present disclosure, Referring to FIG. 21, the pressure sensor in some embodiments includes a first base substrate BS1, a pressure sensing layer PSL on the first base substrate BS1, a releasing via rv extending through the pressure sensing layer PSL, and a sealing layer SL on a side of the pressure sensing layer PSL away from the first base substrate BS1, the sealing layer SL sealing the releasing via rv. The first base substrate BS1 and the pressure sensing layer PSL encapsulate a pressure reference chamber PRC.

The pressure sensor depicted in FIG. 21 differs from the pressure sensor depicted in FIG. 19 in that, in the pressure sensor depicted in FIG. 19, an orthographic projection of the releasing via rv on the first base substrate BS1 is covered by an orthographic projection of the pressure reference chamber PRC on the first base substrate BS1. While, in the pressure sensor depicted in FIG. 21, an orthographic projection of the releasing via rv on the first base substrate BS1 is at least partially non-overlapping with (e.g., at least 10% non-overlapping with, at least 20% non-overlapping with, at least 30% non-overlapping with, at least 40% non-overlapping with, at least 50% non-overlapping with, at least 60% non-overlapping with, at least 70% non-overlapping with, at least 80% non-overlapping with, at least 90% non-overlapping with, at least 99% non-overlapping with, or completely non-overlapping with) an orthographic projection of the pressure reference chamber PRC on the first base substrate BS1,

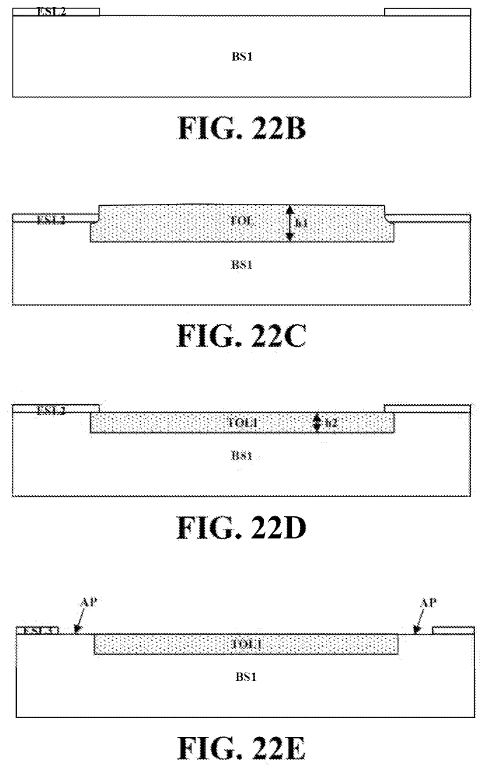

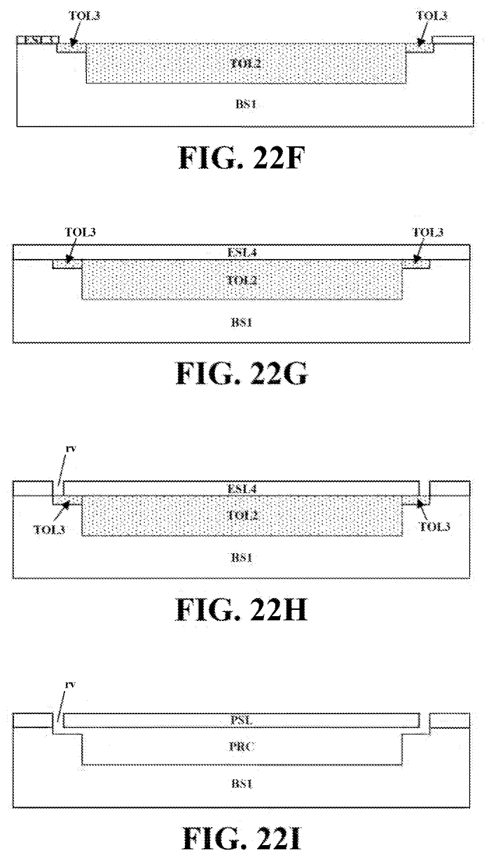

FIG. 22A to 22J illustrates a process of fabricating a pressure sensor in some embodiments according to the present disclosure. Referring to FIG. 22A, a first base substrate BS1 is formed, and a first etch stop layer ESL1 is formed on the first base substrate BS1. In some embodiments, the first base substrate BS1 is a silicon-based base substrate. In one example, the first base substrate BS1 includes single crystal silicon.

In one example, the first etch stop layer ESL1 includes silicon oxide or silicon nitride

Referring to FIG. 22B, the first etch stop layer ESL1 is etched to form a second etch stop layer ESL2. In some embodiments, a central region of the first etch stop layer ESL1 is removed, exposing a portion of the first base substrate BS1. A peripheral region of the first etch stop layer ESL1 at least partially remains, thereby forming the second etch stop layer ESL2.

Referring to FIG. 22C, a thermal oxidation process is performed to treat the portion of the first base substrate BS1 that is exposed. The thermal oxidation process, also known as thermal oxide growth, is a method used to form a layer of oxide on a silicon substrate through a high-temperature oxidation reaction. During the thermal oxidation process, the silicon substrate is exposed to an oxygen-containing atmosphere at elevated temperatures. The most common ambient used is dry oxygen (O2) or a mixture of oxygen and other gases. The oxidation reaction occurs at the surface of the silicon, where oxygen molecules combine with silicon atoms to form silicon dioxide (SiO₂). Typically, the silicon substrate is heated to a high temperature, typically in the range of 800 to 1200 degrees Celsius, in the presence of the oxygen-containing ambient. As the silicon reacts with oxygen, a layer of silicon dioxide is formed on the surface of the silicon substrate. This oxide layer grows gradually, consuming silicon from the substrate. After the desired oxide thickness is achieved, the substrate is annealed at a lower temperature to relieve stress and improve the quality of the oxide layer. The thickness of the thermal oxide layer is determined by several factors, including the oxidation time, temperature, and the concentration of oxygen in the ambient. The growth rate of the oxide layer is generally linear with time under controlled oxidation conditions.

Referring to FIG. 22C, the portion of the first base substrate BS1 that is exposed is subject to the thermal oxidation process, forming a first thermal oxide layer TOL1 having a thickness of h1. When single-crystal silicon is oxidized, the generation of h1 thickness of thermal oxide consumes 0.44*h1 thickness of silicon. As a result, the first thermal oxide layer TOL1 is higher than the surface of the first base substrate BS1 in a region in direct contact with the second etch stop layer ESL2.

In alternative embodiments, the thermal oxidation process is not used. Instead, the first base substrate BS1 is etched to remove a portion of the first base substrate BS1 that is not covered by the second etch stop layer ESL2; and subsequently a dielectric layer is directly deposited on the first base substrate BS1. Optionally, the dielectric layer is formed to have a thickness of 0.44*h1. In one example, the dielectric layer includes silicon oxide.

Referring to FIG. 22C and FIG. 22D, the first thermal oxide layer TOL1 in FIG. 22C can be at least partially removed to have a thickness h2, wherein h2 is less than h1.

Referring to FIG. 22D and FIG. 22E, a portion of the second etch stop layer ESL2 is removed to form a third etch stop layer ESL3, exposing an additional portion AP of the first base substrate BS1.

Referring to FIG. 22E and FIG. 22F, a second thermal oxidation process can be performed on the additional portion AP of the first base substrate BS1 and the first thermal oxide layer TOL1, thereby converting the first thermal oxide layer TOL1 into a second thermal oxide layer TOL2, and converting a part of the additional portion AP of the first base substrate BS1 into a third thermal oxide layer TOL3. The third thermal oxide layer TOL3 and the second thermal oxide layer TOL2 are parts of a unitary structure.

Referring to FIG. 22G, subsequent to forming the third thermal oxide layer TOL3, the third etch stop layer ESL3 is removed. Subsequently, a fourth etch stop layer ESL4 is formed on a side of the second thermal oxide layer TOL2 and the third thermal oxide layer TOL3 away from the first base substrate BS1, Optionally, forming the fourth etch stop layer ESL4 includes depositing a pressure sensing material on a side of the second thermal oxide layer TOL2 and the third thermal oxide layer TOL3 away from the first base substrate BS1.

In one example, the fourth etch stop layer ESL4 includes silicon oxide or silicon nitride. In another example, the fourth etch stop layer ESL4 includes a metal such as platinum (Pt) or chromium (Cr).

In some embodiments, the first base substrate BS1 and the second thermal oxide layer TOL2 have different etching selectivity with respect to a same etchant, e.g., a wet etchant. In one example, the first base substrate BS1 and the second thermal oxide layer TOL2 have different etching selectivity with respect to a fluorine-containing etchant such as hydrogen fluoride, Optionally, the first base substrate BS1 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the second thermal oxide layer TOL2 with respect to the same etchant.

In some embodiments, the first base substrate BS1 and the third thermal oxide layer TOL3 have different etching selectivity with respect to a same etchant, e.g., a wet etchant. In one example, the first base substrate BS1 and the third thermal oxide layer TOL3 have different etching selectivity with respect to a fluorine-containing etchant such as hydrogen fluoride. Optionally, the first base substrate BS1 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the third thermal oxide layer TOL3 with respect to the same etchant.

In some embodiments, the fourth etch stop layer ESLA and the second thermal oxide layer TOL2 have different etching selectivity with respect to a same etchant, e.g., a wet etchant. In one example, the fourth etch stop layer ESL4 and the second thermal oxide layer TOL2 have different etching selectivity with respect to a fluorine-containing etchant such as hydrogen fluoride. Optionally, the fourth etch stop layer ESLA has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the second thermal oxide layer TOL2 with respect to the same etchant.

In some embodiments, the fourth etch stop layer ESLA and the third thermal oxide layer TOL3 have different etching selectivity with respect to a same etchant, e.g., a wet etchant. In one example, the fourth etch stop layer ESL4 and the third thermal oxide layer TOL3 have different etching selectivity with respect to a fluorine-containing etchant such as hydrogen fluoride. Optionally, the fourth etch stop layer ESLA has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the third thermal oxide layer TOL3 with respect to the same etchant.

Referring to FIG. 22H, a releasing via rv is formed to extend through the fourth etch stop layer ESLA. Optionally, the releasing via rv may be formed by an etching process, e.g., using a dry etchant or a wet etchant.

Referring to FIG. 22I, an etchant is used to selectively etch the second thermal oxide layer TOL2 and the third thermal oxide layer TOL3, thereby forming a pressure reference chamber PRC and a pressure sensing layer PSL on a side of the pressure reference chamber PRC away from the first base substrate BS1. The releasing via rv extends through the pressure sensing layer PSL.

Referring to FIG. 22J, a sealing layer SL is formed on a side of the pressure sensing layer PSL away from the pressure reference chamber PRC, sealing the releasing via rv. In one example, the sealing layer SL includes a dielectric material. In another example, the sealing layer SL includes a metallic material. In another example, the sealing layer SL includes a polysilicon material.

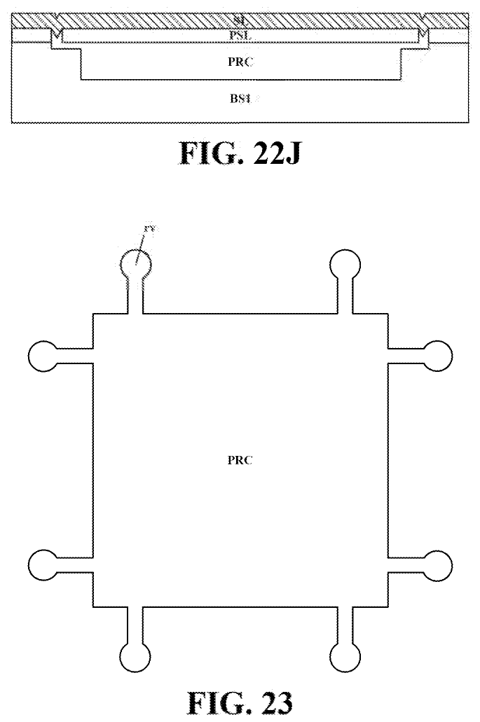

FIG. 23 is a plan view of channels in a pressure sensor in some embodiments according to the present disclosure. As shown in FIG. 23, in some embodiments, an orthographic projection of the releasing via rv on the first base substrate BS1 is at least partially non-overlapping with (e.g., at least 10% non-overlapping with, at least 20% non-overlapping with, at least 30% non-overlapping with, at least 40% non-overlapping with, at least 50% non-overlapping with, at least 60% non-overlapping with, at least 70% non-overlapping with, at least 80% non-overlapping with, at least 90% non-overlapping with, at least 99% non-overlapping with, or completely non-overlapping with) an orthographic projection of the pressure reference chamber PRC on the first base substrate BS1.

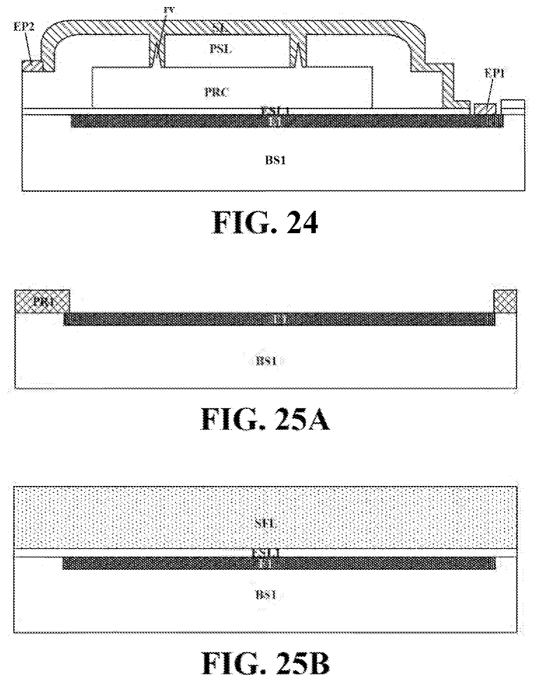

FIG. 24 is a schematic diagram illustrating the structure of a pressure sensor in some embodiments according to the present disclosure. Referring to FIG. 24, the pressure sensor in some embodiments includes a first base substrate BS1, a first electrode E1 on the first base substrate BS1, a first etch stop layer ESL1 on a side of the first electrode E1 away from the first base substrate BS1, a pressure sensing layer PSL on a side of the first etch stop layer ESL1 away from the first base substrate BS1, a releasing via rv extending through the pressure sensing layer PSL, and a sealing layer SL on a side of the pressure sensing layer PSL away from the first base substrate BS1, the sealing layer SL sealing the releasing via rv. The first base substrate BS1 and the pressure sensing layer PSL encapsulate a pressure reference chamber PRC. Optionally, the pressure sensor further includes a first electrode pad EP1 connected to the first electrode E1 and on a side of the first electrode E1 away from the first base substrate BS1. Optionally, the pressure sensor further includes a second electrode pad EP2 on a side of the pressure sensing layer PSL away from the first base substrate BS1.

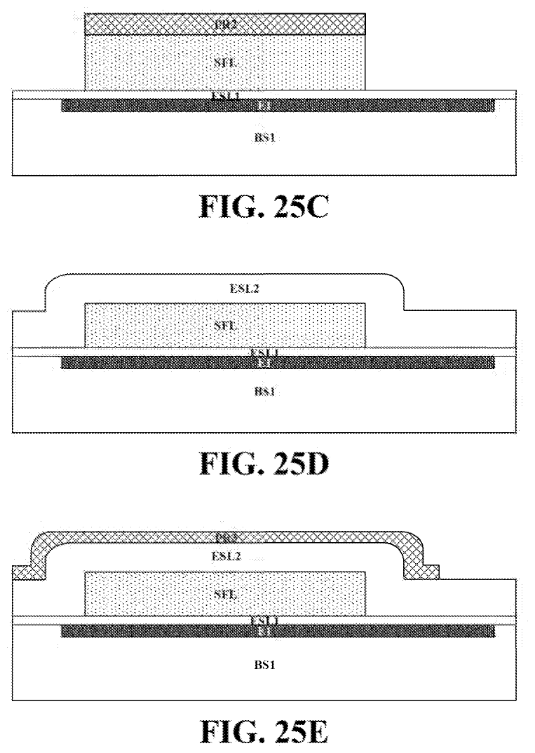

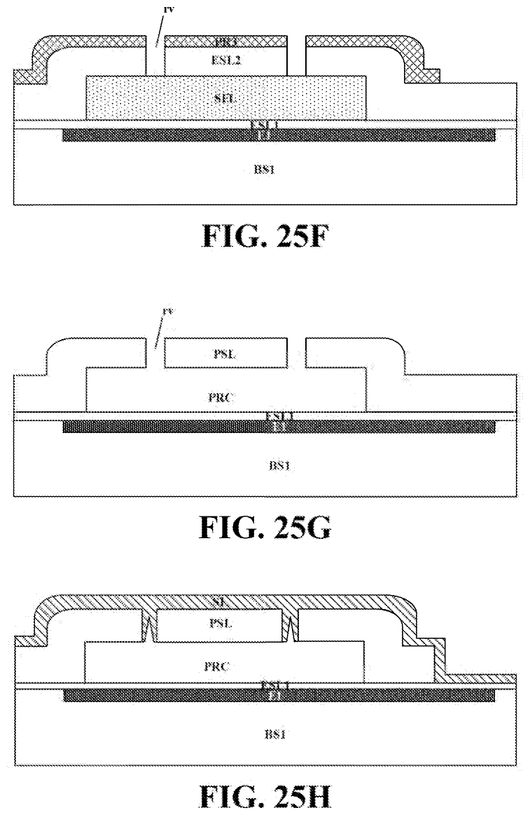

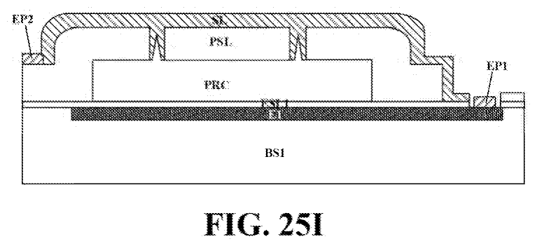

FIG. 25A to 25I illustrates a process of fabricating a pressure sensor in some embodiments according to the present disclosure. Referring to FIG. 25A, a first base substrate BS1 is formed, and a first electrode E1 is formed on the first base substrate BS1. In some embodiments, the first base substrate BS1 is a silicon-based base substrate. In one example, the first base substrate BS1 includes single crystal silicon.

In some embodiments, a first photoresist PR1 is formed on a first region (e.g., a peripheral region) of the first base substrate BS1, and is absent on a second region (e.g., a central region) of the first base substrate BS1: An ion implantation process is performed on the first base substrate BS1 using the first photoresist PR1 as a mask, High-concentration ions are injected to the second region of the first base substrate BS1, forming the first electrode E1.

Referring to FIG. 25A and FIG. 25B, the first photoresist PR1 is removed, a first etch stop layer ESL1 is formed on a side of the first electrode E1 away from the first base substrate BS1, and a sacrificial layer SFL is formed on a side of the first etch stop layer ESL1 away from the first electrode E1. In one example, the first etch stop layer ESL1 includes silicon oxide or silicon nitride. The sacrificial layer SFL can be made from various materials, depending on the manufacturing process and the requirements of the final product. Examples of sacrificial materials include silicon oxide, low-temperature oxide, and phosphosilicate glass. Phosphosilicate may be formed by depositing a layer of glass-like material containing both silicon dioxide (SiO₂) and phosphorus (P) using techniques such as chemical vapor deposition or physical vapor deposition.

Referring to FIG. 25B and FIG. 25C, a second photoresist PR2 is formed on a side of the sacrificial layer SFL away from the first etch stop layer ESL1. The sacrificial layer SFL is etched using the second photoresist PR2 as a mask.

Referring to FIG. 25D, a second etch stop layer ESL2 is formed on a side of the sacrificial layer SFL away from the first etch stop layer ESL1. In one example, the second etch stop layer ESL2 includes a polysilicon material.

Referring to FIG. 25E, a third photoresist PR3 is formed on a side of the second etch stop layer ESL2 away from the sacrificial layer SFL.

Referring to FIG. 25F, a releasing via rv is formed to extend through the third photoresist PR3 and the second etch stop layer ESL2, exposing at least a portion of the sacrificial layer SFL. Optionally, the releasing via rv may be formed by an etching process, e.g., using a dry etchant or a wet etchant.

Referring to FIG. 250, the third photoresist PR3 is removed, and an etchant is used to selectively etch the sacrificial layer SFL, thereby forming a pressure reference chamber PRC and a pressure sensing layer PSL on a side of the pressure reference chamber PRC away from the first etch stop layer ESL1. The releasing via rv extends through the pressure sensing layer PSL.

Referring to FIG. 25H, a sealing layer SL is formed on a side of the pressure sensing layer PSL away from the pressure reference chamber PRC, sealing the releasing via ry. In one example, the sealing layer SL includes a dielectric material. In another example, the sealing layer SL includes a metallic material. In another example, the sealing layer SL includes a polysilicon material.

Referring to FIG. 25I, a first electrode pad EP1 is formed on a side of the first electrode BI away from the first base substrate BS1, and connected to the first electrode E1; and a second electrode pad EP2 is formed on a side of the pressure sensing layer PSL away from the first base substrate BS1, Optionally, prior to forming the first electrode pad EP1 and the second electrode pad EP2, an adhesion layer is first deposited on the pressure sensing layer PSL and/or the first electrode E1. In one example, the adhesion layer includes titanium, tantalum, or chromium.

In some embodiments, the first etch stop layer ESL1 and the sacrificial layer SFL have different etching selectivity with respect to a same etchant, e.g., a wet etchant. In one example, the first etch stop layer ESL1 and the sacrificial layer SFL have different etching selectivity with respect to a fluorine-containing etchant such as hydrogen fluoride. Optionally, the first etch stop layer ESL1 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the sacrificial layer SEL with respect to the same etchant.

In some embodiments, the second etch stop layer ESL2 and the sacrificial layer SFL have different etching selectivity with respect to a same etchant, e.g., a wet etchant. In one example, the second etch stop layer ESL2 and the sacrificial layer SFL have different etching selectivity with respect to a fluorine-containing etchant such as hydrogen fluoride. Optionally, the second etch stop layer ESL2 has an etching rate with respect to the same etchant at least less than 50% of (e.g., at least less than 55% of, at least less than 60% of, at least less than 65% of, at least less than 70% of, at least less than 75% of, at least less than 80% of, at least less than 85% of, at least less than 90% of, at least less than 95% of, at least less than 98% of, or at least less than 99% of) an etching rate of the sacrificial layer SFL with respect to the same etchant.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A sensor chip, comprising:
a first base substrate;
a piezoresistor and a resistor lead on the first base substrate;
a second base substrate on a side of the piezoresistor and the resistor lead away from the first base substrate;
a metal wire bond extending through the second base substrate and connected to the resistor lead;
a redistribution layer on a side of the second base substrate away from the first base substrate; and
a pressure reference chamber between the first base substrate and the second base substrate;
wherein the first base substrate and the second base substrate encapsulate at least a portion of the piezoresistor inside the pressure reference chamber;
the metal wire bond is connected to the resistor lead, and is connected to the redistribution layer; and
the resistor lead is connected to the piezoresistor.

2. The sensor chip of claim 1, further comprising an under bump metallization on a side of the second base substrate away from the first base substrate; and
a solder on a side of the under bump metallization away from the second base substrate and connected to the under bump metallization.

3. The sensor chip of claim 1, comprising a via extending through the second base substrate;
wherein the metal wire bond is at least partially in the via;
the via has a trapezoidal shape with an included angle between a top side and a lateral side; and
the included angle is in a range of 80 degrees to 90 degrees.

4. The sensor chip of claim 1, comprising a pressure sensing layer configured to convert a pressure signal into a deformation signal;
wherein the pressure sensing layer comprises a portion of the first base substrate between the two piezoresistors; and
the piezoresistor is configured to convert the deformation signal into an electrical signal.

5. The sensor chip of claim 4, wherein a surface of the portion of the first base substrate between the two piezoresistors is exposed to the pressure reference chamber.

6. The sensor chip of claim 1, further comprising an insulating layer on the first base substrate;
wherein the piezoresistor and the resistor lead are on a side of the insulating layer away from the first base substrate;
the pressure reference chamber is between the insulating layer and the second base substrate; and
the insulating layer and the second base substrate encapsulate at least a portion of the piezoresistor inside the pressure reference chamber.

7. The sensor chip of claim 6, comprising a pressure sensing layer configured to convert a pressure signal into a deformation signal;
wherein the pressure sensing layer comprises a portion of the first base substrate and a portion of the insulating layer between two piezoresistors; and
the piezoresistor is configured to convert the deformation signal into an electrical signal.

8. The sensor chip of claim 7, wherein a surface of the portion of the insulating layer between the two piezoresistors is exposed to the pressure reference chamber.

9. The sensor chip of claim 1, further comprising a thermistor on a side of the second base substrate away from the first base substrate.

10. The sensor chip of claim 1, further comprising a hygrometer on a side of the second base substrate away from the first base substrate.

11. A pressure sensor, comprising:
a first base substrate;
a pressure sensing layer on the first base substrate;
a releasing via extending through the pressure sensing layer;
a sealing layer on a side of the pressure sensing layer away from the first base substrate, the sealing layer sealing the releasing via; and
a pressure reference chamber between the first base substrate and the pressure sensing layer.

12. The pressure sensor of claim 11, further comprising:
a first etch stop layer on the first base substrate and on a side of the pressure reference chamber closer to the first base substrate; and
a second etch stop layer on a side of the first etch stop layer away from the first base substrate, the second etch stop layer surrounding a periphery of the pressure reference chamber;
wherein the pressure sensing layer, the first etch stop layer, and the second etch stop layer encapsulate the pressure reference chamber.

13. The pressure sensor of claim 12, wherein the second etch stop layer comprises doped polycrystalline silicon.

14. The pressure sensor of claim 11, wherein the first base substrate and the pressure sensing layer encapsulate the pressure reference chamber.

15. The pressure sensor of claim 11, further comprising:
a first electrode on the first base substrate; and
a first etch stop layer on a side of the first electrode away from the first base substrate;
wherein the pressure sensing layer and the first etch stop layer encapsulate the pressure reference chamber.

16. The pressure sensor of claim 11, wherein an orthographic projection of the pressure reference chamber on the first base substrate covers an orthographic projection of the releasing via on the first base substrate.

17. The pressure sensor of claim 11, wherein an orthographic projection of the releasing via on the first base substrate is at least partially non-overlapping with an orthographic projection of the pressure reference chamber on the first base substrate.

18. A method of forming a pressure sensor, comprising:
forming a pressure sensing layer on a first base substrate;
forming a releasing via extending through the pressure sensing layer;
forming a sealing layer on a side of the pressure sensing layer away from the first base substrate, the sealing layer sealing the releasing via; and
forming a pressure reference chamber between the first base substrate and the pressure sensing layer.

19. The method of claim 18, further comprising:
forming a first etch stop layer on the first base substrate;
forming a sacrificial layer on a side of the first etch stop layer away from the first base substrate;
performing an ion implantation process on a portion of the sacrificial layer, thereby forming a second etch stop layer in a peripheral region of the sacrificial layer;
forming a third etch stop layer on a side of the sacrificial layer and the second etch stop layer away from the first etch stop layer;
forming the releasing via extending through the third etch stop layer; and
selectively removing the sacrificial layer, thereby forming the pressure reference chamber.

20. The method of claim 19, wherein the first etch stop layer has an etching rate with respect to a same etchant at least less than 50% of an etching rate of the sacrificial layer with respect to the same etchant;
the second etch stop layer has an etching rate with respect to the same etchant at least less than 50% of the etching rate of the sacrificial layer with respect to the same etchant; and
the third etch stop layer has an etching rate with respect to the same etchant at least less than 50% of the etching rate of the sacrificial layer with respect to the same etchant.

21. (canceled)

22. (canceled)

23. (canceled)

24. (canceled)

25. (canceled)

26. (canceled)
